(19) United States
(12) Patent Application Publication
(10) Pub. No.: US 2014/0001781 A1
(43) Pub. Date: Jan. 2, 2014

(54) Shock Absorbing Trailer Hitch Attachment

(71) Applicant: Michael Leking, Duxbury, MA (US)

(72) Inventor: Michael Leking, Duxbury, MA (US)

(21) Appl. No.: 13/534,222

(22) Filed: Jun. 27, 2012

(51) Int. Cl. B60R 19/26

(52) U.S. Cl. CPC B60R 19/26
USPC 293/135

(57) ABSTRACT

A shock absorbing trailer hitch attachment for vehicle protection is presented. A shock absorbing attachment is inserted into the trailer hitch receiver tube of any vehicle with an existing trailer hitch. The trailer hitch attachment contains shock absorbing capabilities and is designed to compress in order to reduce impact to the vehicle. Specifically, this attachment minimizes the amount of shock forces on a vehicle's bumper, via impact, between other vehicles, structures, and objects. The attachment does not require alteration of existing trailer hitch receivers and will add purpose to the routinely underutilized trailer hitch.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

The present invention is a trailer hitch accessory. More particularly, it provides vehicle protection through a shock absorbing attachment within existing trailer hitch receiver tubes.

### BACKGROUND OF THE INVENTION

A trailer hitch receiver tube, also known as a tow hitch, is a device that is physically attached to the rear frame of a vehicle, in which a ball mount is inserted to enable towing capabilities. Many trailer hitches have an opening, or receiver, in which accessories or other attachment options may be inserted. Trailer hitch attachments come in different shapes and sizes, and can be used on any Class trailer hitch, which typically range in sizes from 1.25-2.5 inches. North American trailer hitches are classified by the Society of Automobile Engineers (SAE) and common classifications include Class I, II, III, IV, and V.

Traditional trailer hitches are secured to a vehicle's chassis and are structurally designed to tow large, and at times heavy, loads depending on the make of the vehicle. Trailer hitches are capable of receiving a variety of attachment options. There is a large variety in the types of attachments that may be inserted into the square receiver tube or sleeve of a trailer hitch; some examples include: portable grills, sun protection shades, non-absorbing bumper extension steps, receiver tube covers or caps, cargo shelves, etc. While these trailer hitch accessories serve specific purposes, such trailer hitch attachments do not provide shock-absorbing capabilities and vehicle protection when the vehicle comes in contact with a vehicle, structure, or object.

More often than not, trailer hitches are underutilized; for example, the receiver tube is generally empty and doesn't provide any benefit to the vehicle. Trailer hitches can be used to help protect the rear of a vehicle. Vehicles with trailer hitches have the ability to receive an attachment that can provide shock absorbing capabilities to help protect the bumper, and the bumpers of other vehicles. SUVs and pickup truck-beds may extend more than five feet from the cab, making it difficult for the driver to judge the distance between the vehicle's bumper and another object when backing up. Minor impacts and low speed collisions can have serious repercussions on a vehicle, and its bumper. The cost of repairing, or repainting, a vehicle's bumper can be very expensive and inconvenient.

There are many trailer hitch accessories available that serve specific purposes, however, there is an absence of attachments that provide effective shock absorbing capabilities for use at all times.

### SUMMARY OF THE INVENTION

Vehicles attempting to parallel-park, reverse into parking spots, or drive backwards, are highly susceptible to bumper damage as the driver may not accurately judge the distance between the vehicle's bumper and other vehicles, structures, and objects. The shock absorbing trailer hitch attachment of the present invention is designed to fit into a vehicle's trailer hitch receiver tube and provide a resilient, resisting force upon impact, which will ultimately prevent or help to minimize damage to the bumper and vehicle. In the event that a vehicle hits another vehicle, wall, structure, or object, the shock absorbing trailer hitch attachment will absorb the impact resulting from low speed vehicle impacts or collisions.

Current trailer hitch attachments fail to combine the functionality of bumper protection accessories into an efficient, lightweight, and compact mechanism that protects the vehicle's bumper, yet fits within the confines of the trailer hitch receiver. The trailer hitch attachment of the present invention comprises a resilient member, such as a coil spring, an accordion member or a folding member or other similar resilient structure, attached to a tubular member which may be inserted at least partially into the receiver hitch tube and may extend outward away from the vehicle bumper, so as to allow the resilient member to compress and thereby absorb energy upon an impact resulting from a low speed collision. In a collision, the resilient member compresses and retracts in the same direction as the force being applied by the obstacle struck, reducing the kinetic energy upon impact with the object. The trailer hitch attachment of the present invention is aesthetically pleasing and functional due to its size, utility, practical application, and relatively low cost to manufacture.

The shock absorbing trailer hitch attachment contains a resilient member, which may for example be a non-rust compression spring or other structure having similar resilient functionality that will retract upon impact. It will prevent the vehicle's bumper from making contact with objects that might damage the bumper, and help to minimize damage that might be caused by a collision, due to the trailer hitch attachment's shock absorbing property. The trailer hitch attachment of the present invention is made for slow speed collisions/impact at low speeds and will protect both the vehicle and the impact source (wall, vehicle, planters, barriers, etc.). An end-cap is attached to the outer most edge of the shock absorbing trailer hitch attachment. The purpose of the end-cap is to make initial contact with an impact source, which will then cause the resilient member to retract and absorb the applied force resulting from the impact. The end-cap is constructed of hard plastic or rubber or other impact resistant material which will help to prevent marks/scratches on a vehicle or other object with which the end-cap comes in contact in the event of an impact.

The trailer hitch attachment of the present invention may be used on factory and after-market trailer hitches and will be scaled to the size of the trailer hitch receiver tube openings, which may be for example, 1.25 inches, 2 inches, and 2.5 inch or other appropriate dimension. A vehicle with the trailer hitch attachment of the present invention installed shall be referred to as the “primary vehicle.” The shock absorbing trailer hitch attachment is used to prevent damage to the primary vehicle's bumper in the event that the primary vehicle hits or is hit by, a vehicle, structure, or object. In the event of an impact, kinetic energy is dissipated from the trailer hitch of the primary vehicle via the resilient member which absorbs some of the force of the impact and transfers the remaining force to the solid frame of the primary vehicle.

The shock absorbing trailer hitch attachment can also be used on vehicles that currently have back-up assist technology, such as cameras and audible chimes. Such technologies are susceptible to malfunction (camera lens may be cracked or inoperable), may be miscalibrated, may be inoperable (camera lens may be dirty or otherwise obstructed) or may not be applicable (drivers may be hearing impaired and won't be able to hear the chimes). The shock absorbing trailer hitch attachment may be used to augment existing technologies and provides redundancy with regards to vehicle protection. The trailer hitch attachment of the present invention may serve as an additional sensor for the driver, who will sense the resistance if the attachment encounters an obstacle such as another vehicle, a wall or an object when the primary vehicle is moving in reverse. Upon sensing such resistance, the driver can stop the rearward movement of the primary vehicle and avoid what might otherwise be severe damage to the primary vehicle and/or the obstacle.

When not being used to tow, the primary vehicle's trailer hitch does not provide any benefit to the primary vehicle. Vehicles equipped with the shock absorbing trailer hitch attachment of the present invention will be better prepared to avoid or reduce damage due to low speed rear end impacts and will thereby increase the usefulness of the often-times underutilized trailer hitch.

### BRIEF DESCRIPTION OF THE FIGURES

The following figures are practical illustrations of exemplary embodiments of the present invention, which do not limit the scope or objectives of the invention. The figures should be used in conjunction with the explanations in the following detailed description.

FIG. 1 illustrates a conventional trailer hitch receiver.

FIG. 2 is a three-quarter perspective view of one embodiment which shows the components of the shock absorbing trailer hitch attachment.

FIGS. 3a-d illustrates various views of one shock absorbing trailer hitch embodiment with absorption capabilities provided by a compression spring abutted against the opening of the trailer hitch receiver tube.

FIGS. 4a-4b shows cross-sectional views which demonstrate the shock absorbing capability of one embodiment.

FIG. 5 is a three-quarter perspective view of a second embodiment which shows the components of the shock absorbing trailer hitch attachment.

FIGS. 6a-d illustrates various views of the second embodiment of the shock absorbing trailer hitch attachment with a compression spring located inside of round tubes that are inserted into the trailer hitch receiver tube.

FIGS. 7a-b shows cross-sectional views which demonstrate the shock absorbing capability of a second embodiment of the shock absorbing trailer hitch attachment.

### DETAILED DESCRIPTION OF THE INVENTION

The present invention is described in one or more embodiments in the following description with references to the Figures, where reference numerals denote the elements and components within the figures. The following documentation and drawings articulate the invention's scope and objectives, which cover alternatives, modifications, and equivalents in similar spirit and scope as supported by the appended, and equivalent, descriptions and claims. Those skilled in the art may recognize that suitable alternatives may be substituted for elements, components, or configurations of the present invention and those modifications will not deter from the scope, applicability, or objectives of the present invention.

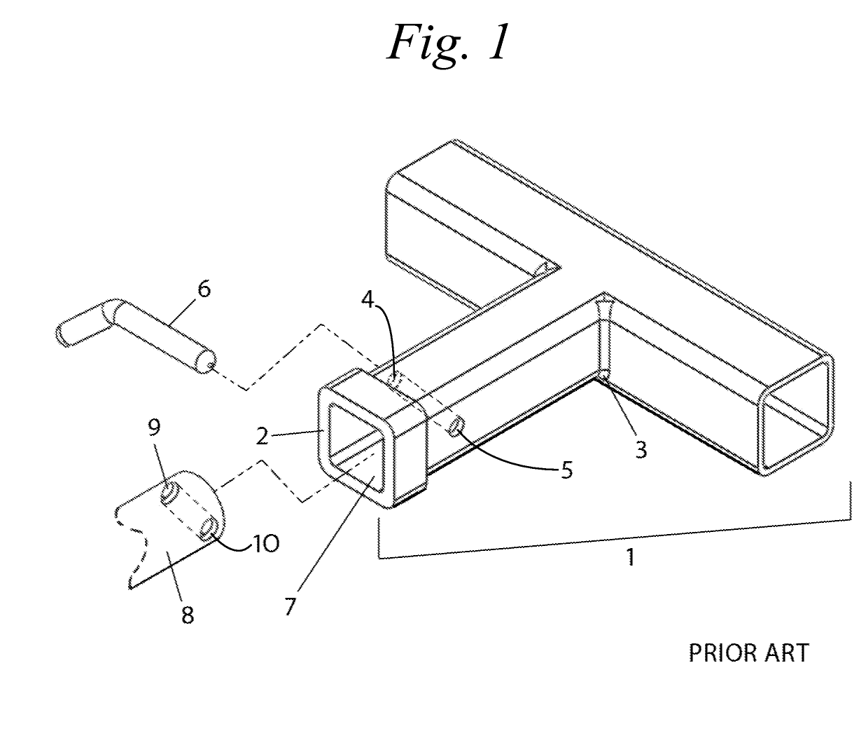

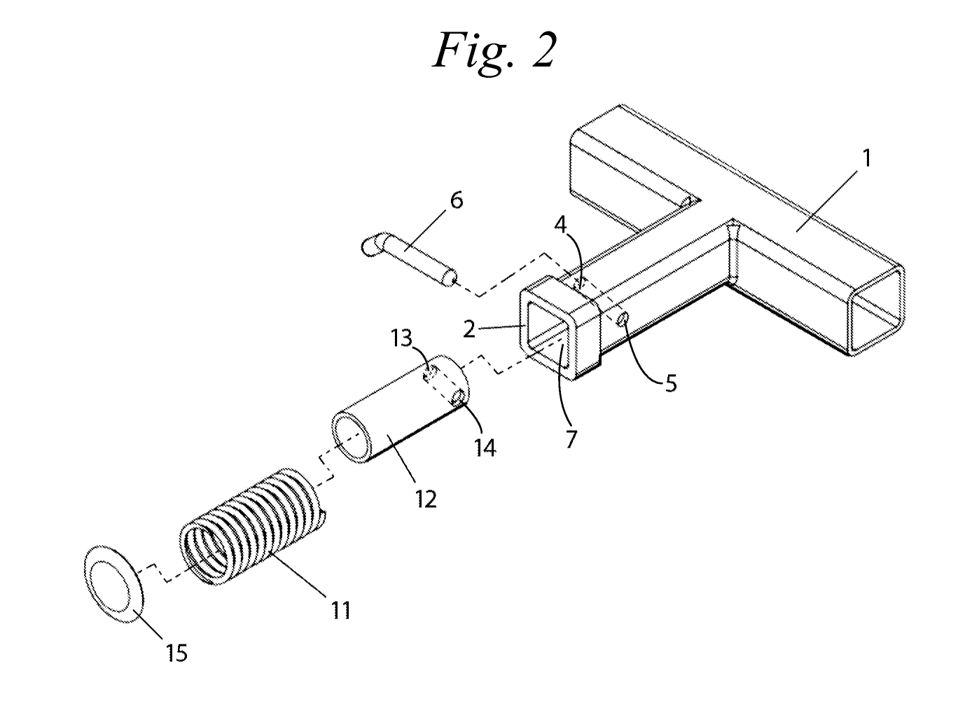

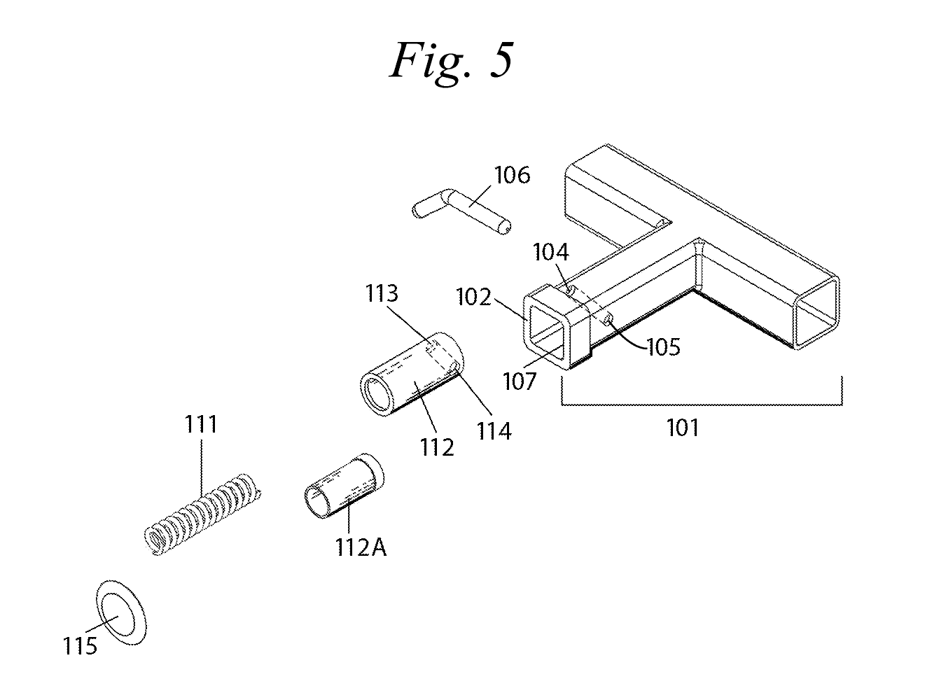

FIG. 1, illustrates a conventional trailer hitch receiver tube. FIGS. 2-4b represent one embodiment of the present invention illustrating its shock absorption capabilities via a compression spring resting against the opening of the trailer hitch receiver tube. FIGS. 5-7b represent a second embodiment where the resilient member is a coil spring located inside of interlocking tubes that are inserted within the trailer hitch receiver.

Referencing FIG. 1, a conventional trailer hitch receiver is illustrated. The trailer hitch is typically mounted to the chassis of a vehicle. The vehicle may be a car, truck, SUV, bus, golf cart, or other type of wheeled vehicle suitable for towing another vehicle or object. The receiver 1 portion of the trailer hitch is depicted in FIG. 1.

The receiver 1 is comprised of a square tubular body 2. The interior of the tubular body 2 is hollow. One end of the tubular body 2 is connected to the body of the receiver-type trailer hitch 3. The openings of trailer hitches are measured in horizontal and vertical dimensions, for example, 1.25 inches for SAE Class I hitches to 2.5 inches for some SAE Class V hitches.

Holes 4 and 5 are configured on the vertical walls of the square tubular body 2. The holes 4 and 5 are configured to receive a retaining, or hitch pin 6. The trailer hitch opening 7 receives the trailer connecting member 8 to attach a trailer for towing. Only the end of the trailer connecting member 8 is depicted. Holes 9 and 10 are aligned on an axis and configured on opposite sides of the trailer connecting member 8 to receive hitch pin 6.

The trailer connecting member 8 is sized to fit into the trailer hitch opening 7. The trailer connecting member 8 is inserted into the trailer hitch opening 7 and the holes 9 and 10 on the trailer connecting member 8 are aligned with the holes 4 and 5 on the tubular body 2. The locking hitch pin 6 is inserted through holes 4, 9, 10, and 5 to securely connect the trailer hitch with the trailer connecting member 8.

FIG. 2 depicts components of one embodiment of the shock absorbing trailer hitch attachment of the present invention with the receiver 1 portion of the trailer hitch and the hitch pin 6. In this embodiment, the resilient member of the trailer hitch attachment is a coil compression spring 11. The spring 11 exerts a resilient, resisting force when an object comes into contact with the trailer hitch attachment, which helps to prevent damage to the vehicle and/or the object. This embodiment of the trailer hitch attachment further comprises a tubular member 12 having an outside diameter that allows insertion of the tubular member 12 into the trailer hitch opening 7 of the receiver square tubular body 2. Holes 13 and 14 are aligned on an axis near one end of the tube 12. The inner diameter of the spring 11 is the same size, or slightly larger than the outer diameter of the tubular member 12. The spring 11 may be inserted over and secured to a portion of the tube 12 (at the end of the tube that does not have cross-holes 13 and 14). The location of the spring 11 on the tube 12 is important so that when the assembled trailer hitch attachment is inserted into the trailer hitch receiver opening 7, the spring 11 will rest against the perimeter of the trailer hitch opening 7 and the holes 13 and 14 in the tube 12 will align with the holes 4 and 5 of the trailer hitch receiver tube. Any appropriate method for securely attaching the spring 11 to the tube 12, including for example welding, fasteners, and/or indentations on the tube or a combination of such methods, may be among the methods used to securely attach the spring 11 to the tube 12. The outer dimension of the tube 12 may be about the same nominal dimension as the hitch receiver tube, e.g., a tube with about a 2 inch diameter may be inserted into about a 2 inch by 2 inch square receiver tube. In this embodiment, the tube 12 allows the trailer hitch attachment to be secured to the trailer hitch receiver 1 via holes 13 and 14. Holes 13 and 14 are on the same axis and are located near one end of the tube 12. These holes 13 and 14 are the same size, or slightly larger than the corresponding holes 4 and 5 on the trailer hitch receiver 1 through which hitch pin 6 is inserted. The hitch pin 6 secures the tube 12 with attached spring 11 to the vehicle's trailer hitch receiver tube 2. Once the combined spring 11 and the tube 12 are inserted into the vehicle's trailer hitch receiver tube 2, the hitch pin 6 will be inserted through the holes 4 and 5 of the vehicle's trailer hitch receiver tube 2 and through holes 13 and 14 of the tubular member 12, thereby securing tubular member 12 with attached spring 11 to the vehicle's trailer hitch.

An end-cap 15 is the primary element of this embodiment that will make contact with an object, e.g., vehicle, structure, wall, etc. The end-cap 15 is secured to the outward facing end of the compression spring 11. The bond between the end-cap 15 and the spring 11 may be made with any appropriate means, including for example welding or through the use of fasteners or a combination of welding and/or fasteners. The end-cap 15 may also be affixed to the inside of the spring 11. The end-cap 15 is strong and durable, and may be made of any appropriate resistant material, including for example metal, hard plastic, rubber or similar material and/or combinations of such materials, as its function is to make contact with objects or obstacles at varying degrees of speeds and angles. Combinations of different materials may be employed in different locations on the end-cap 15. For example, the outer edge portion of the end-cap may be rubber, plastic, or a similar material and the inner portion of the end-cap may be comprised of metal or other similar material and vice versa. A variety of different shapes and designs may also be used for the end-cap 15 to provide an aesthetic effect; provided the shapes and designs are suitable for the end-cap's intended purpose of limiting damage upon impact. The end-cap can also include corporate logos or company names. The order of assembly of the components of the trailer hitch attachment of this embodiment of the present invention may vary. For example, the end-cap 15 may be attached to the spring 11 before or after the spring has been attached to the tube 12.

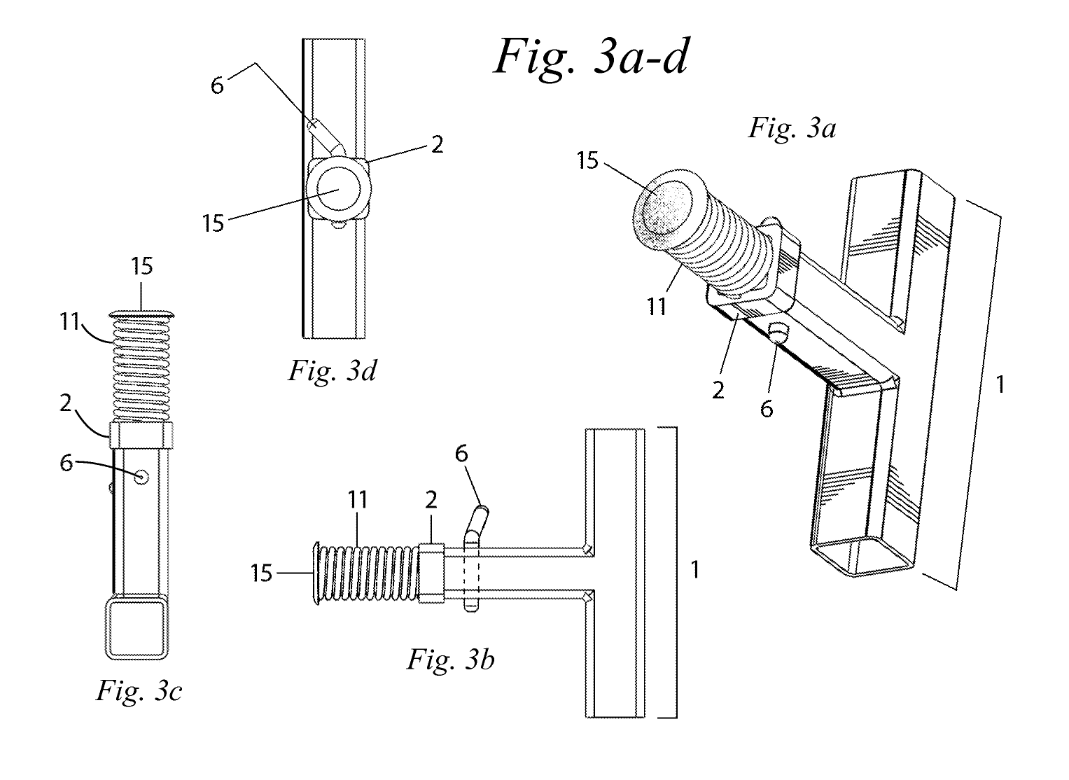

FIGS. 3a-d illustrate various views of a fully integrated FIG. 2 embodiment of the present invention. In these views, the shock absorbing trailer hitch attachment is secured to the trailer hitch receiver 1 as the hitch pin 6 has been inserted through the holes of the trailer hitch receiver tubular body. FIG. 3a is a perspective view of the FIG. 2 embodiment of the shock absorbing trailer hitch attachment secured to the trailer hitch receiver tube 2. FIG. 3b is an overhead view of the same embodiment. FIG. 3c is a side view of the FIG. 2 embodiment and FIG. 3d is a frontal view. As shown in FIGS. 3a-3c, the spring 11 is resting against the perimeter of the opening 7 of the hitch receiver tube 2. As shown, the embodiment is secured to the vehicle trailer hitch and ready to absorb impact and resulting kinetic energy through the mechanics of the spring.

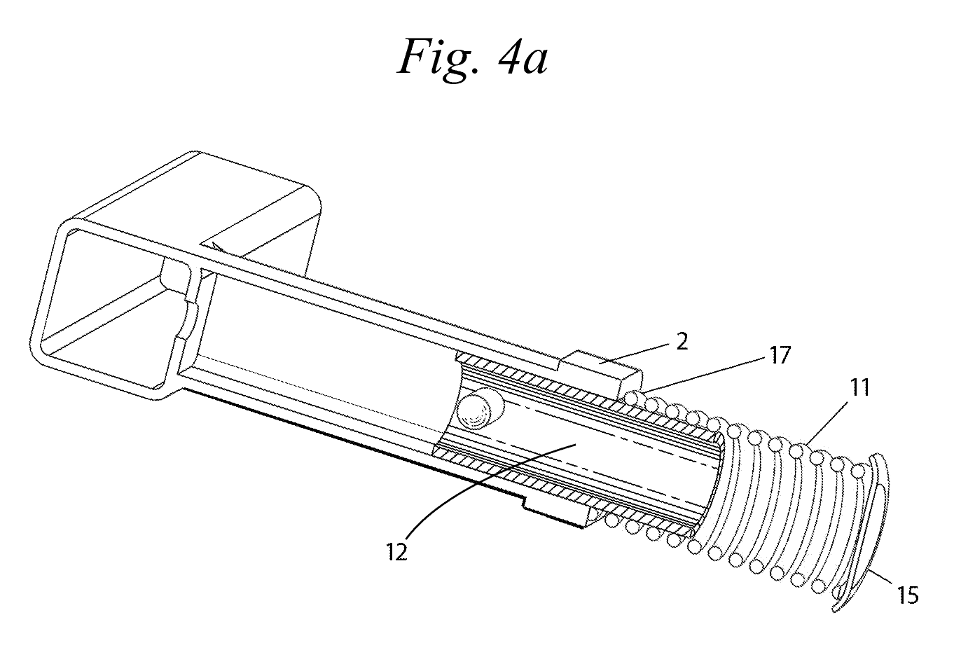

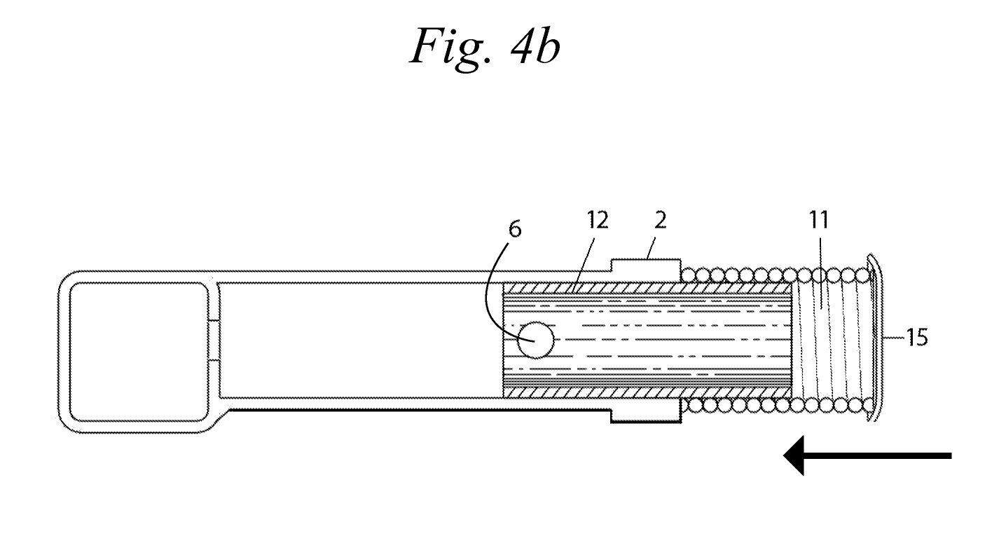

FIGS. 4a-b shows a cross-sectional view of all components of the FIG. 2 embodiment. The compression spring 11 is wrapped around the tube 12. The spring 11 is situated on the tube 12 so that when the tube 12 is secured to the hitch, the edge 17 of the spring 11 will touch the perimeter of the opening 7 of the trailer hitch receiver into which the tube 12 is inserted. The two holes 13 and 14 (not shown) in the tube 12 may be slightly larger than the diameter of the two holes 4 and 5 (not shown) in the trailer hitch receiver 2 to account for slight measurement differences of different hitch models and/or manufacturers. FIG. 4a depicts the embodiment in the ready position. FIG. 4b shows the embodiment in the fully compressed position against the trailer hitch. The spring 11 universally compresses along its length around the tube 12 in the direction shown by the arrow when the end-cap 15 of this embodiment comes into contact with an object.

In FIG. 5, a second embodiment of the shock absorbing trailer hitch attachment is depicted. Like the FIG. 2 embodiment, this embodiment is also inserted into existing trailer hitches and utilizes a compression coil spring as a resilient member to help prevent vehicle damage. The mechanics of this second embodiment differ, however, as the compression coil spring is located within interlocking tubes. As shown in FIG. 5, this embodiment comprises two interlocking tubes 112 and 112A which permit movement of the smaller tube 112A in one direction. The diameter of the larger tube 112 permits its insertion into the opening 107 of the hitch receiver tube 102, e.g., a round tube with about a 2 inch diameter can be inserted into about a 2 inch by 2 inch square receiver tube. Toward one end of the larger tube 112, two holes, 113 and 114, provide the means to secure the tube 112 with hitch pin 106 to the trailer hitch receiver 1. These holes 113 and 114 toward one end of the larger tube 112 are about the same size as the corresponding holes 104 and 105 in the trailer hitch receiver tubular body 102. The opposite end of the larger tube 112 has a rounded (inward) edge, which will interlock with the rounded (upward) edge of the smaller tube 112A to create one interlocking elongated, telescoping tubular assembly in a manner well known to those skilled in the art. The larger tube 112 of this elongated, telescoping tubular assembly is secured to the trailer hitch receiver body 102 via hitch pin 106, and extends outward from the trailer hitch receiver.

The smaller tube 112A provided for this second embodiment fits inside the larger tube 112. The smaller tube's 112A outer diameter is less than the inner diameter of the larger tube 112, e.g., if the inner diameter of the larger tube 112 is about 1.7 inches, the outer diameter of the smaller tube 112A is approximately 1.65 inches or less. At one end, the smaller tube 112A has an edge that is rounded, or curved, upwards and will fit inside the larger tube 112. This rounded upward edge of the smaller tube 112A will rest against a rounded downward edge of the larger tube 112 in a manner well known to form an interlocking, elongated telescoping tubular assembly when the smaller tube 112A is inserted into the larger tube 112. The interlocking downward and upward edges secure the assembled tubes together and prevent their separation from each other when the assembly is secured to the trailer hitch receiver body. An end-cap 115 is secured onto the opposite end of the smaller tube 112A. The end-cap 115 may be secured to the smaller tube 112A through various securing techniques, such as for example, welding, fasteners, or clips or combinations thereof.

The size of the compression spring 111 may be scaled according to the overall length of the trailer hitch attachment and the inner diameter of the tubes 112, 112A. The compression spring 111 is positioned within the tubes 112 and 112A with one end of the spring 111 resting against the hitch pin 106 and the other end of the spring 111 resting against the end-cap 115. When the end-cap 115 comes into contact with an object, the spring 111 situated within both tubes 112 and 112A will compress against the hitch pin 106.

It is important to describe the integration assembly process of the second embodiment as there are interlocking components. The upward facing edge of the smaller tube 112A should be inserted into the end of the larger tube 112 near the two holes 113, 114. The smaller tube 112A should lock into place within the larger tube 112 as the rounded edges of both tubes will touch. The end-cap 115 is fastened to the non-interlocking end of the smaller tube 112A. At this point, compression spring 111 may be inserted into the remaining open end of the larger tube 112 (the end near the two cross-holes 113, 114) and then into the smaller tube 112A, so that one end of the spring 111 rests against the end-cap 115. Once all the components have been integrated, the assembly may be inserted into the trailer hitch receiver tube 102 and secured to the trailer hitch receiver by inserting the hitch pin 106 through the hitch receiver holes 104, 105 as well as the holes 113, 114 of the large tube 112. The order of assembly may vary as the spring 111 may be attached to the end-cap 115 before the end-cap 115 is secured to the non-interlocking free end of the smaller tube 112A.

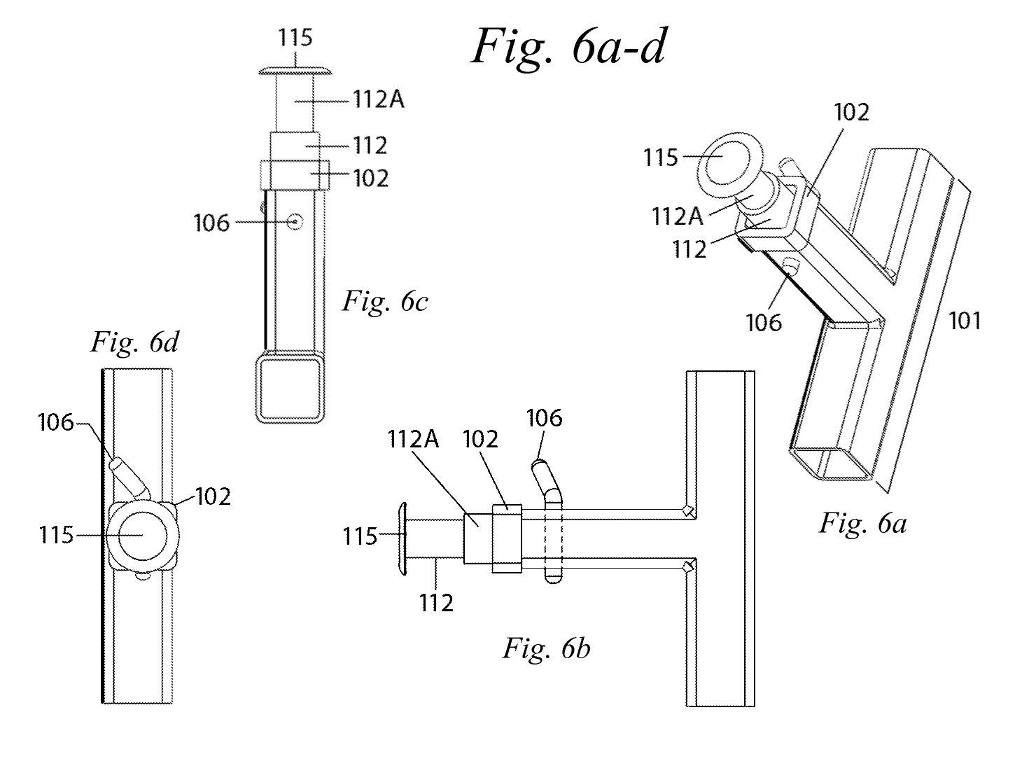

FIGS. 6a-d illustrate various views of the fully integrated embodiment of FIG. 5. In these views, the shock absorbing trailer hitch attachment is shown secured to the trailer hitch receiver 101 as the hitch pin 106 has been inserted through both holes 104, 105 of the trailer hitch receiver tube 102. The tubes 112, 112A are integrated together and interlocked and an end-cap 115 is located on the outermost edge of the assembled embodiment. At this point, the embodiment is secured to the vehicle and ready to absorb impact, and resulting kinetic energy, through the mechanics of the spring 111. FIG. 6a is a perspective view of the FIG. 5 embodiment of the shock absorbing trailer hitch attachment secured to the trailer hitch receiver tube 102. FIG. 6b is an overhead view of the same embodiment. FIG. 6c is a side view of the FIG. 5 embodiment and FIG. 6d is a frontal view.

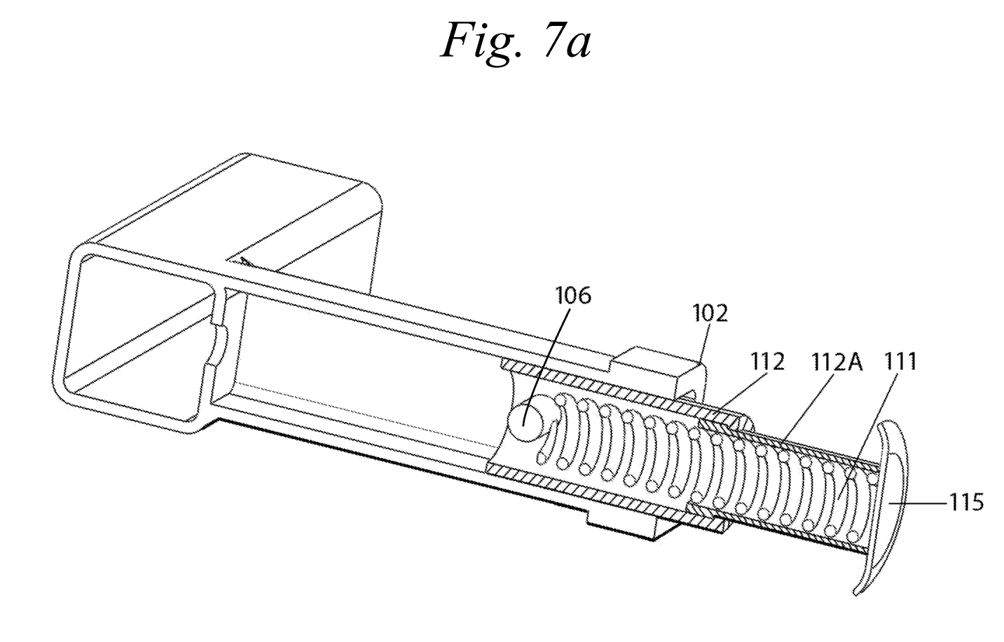

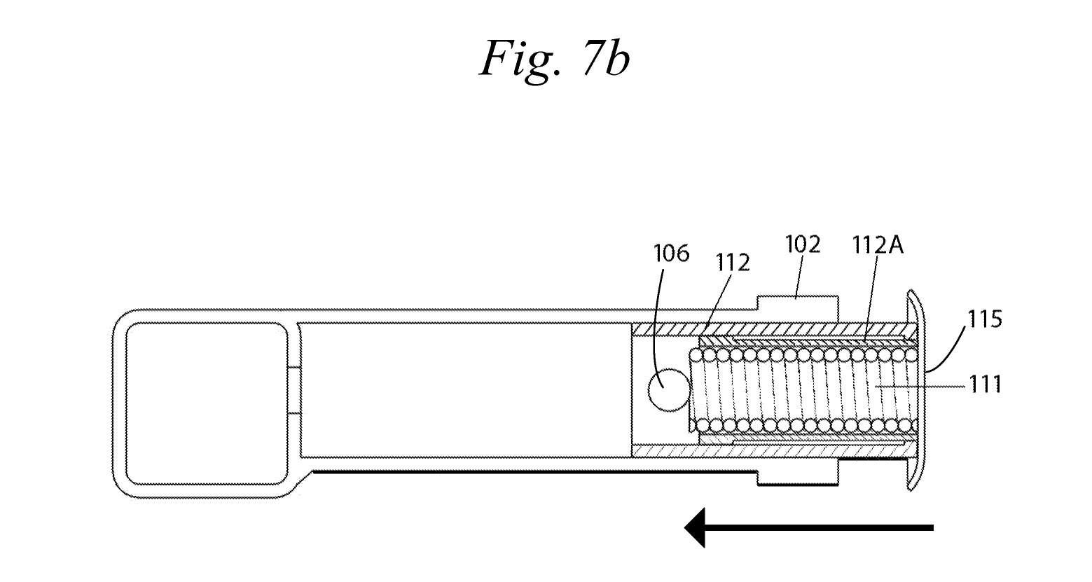

FIGS. 7a-b show a cross-sectional view of all components of the FIG. 5 embodiment of the present invention. These figures demonstrate the location and functionality of the components. FIG. 7a shows the inner workings of the embodiment where the compression spring 111 is located within two tubes 112, 112A with one end of the spring 111 resting against the end-cap 115 and the other end of spring 111 resting against the hitch pin 106. The spring 111 and tubes 112, 112A extend outward from the trailer hitch receiver and are designed to compress/collapse in a controlled manner. FIG. 7b illustrates the embodiment's ability to absorb energy through compression. The spring 111 is fully compressed against the hitch pin 106 and end-cap 115, within both tubes 112, 112A.

These embodiments of the present invention take seconds to install/uninstall and fit snugly into a trailer hitch receiver tube and protect the trailer hitch receiver's inner-walls from deterioration and wear caused by natural elements. A standard hitch pin 106 may be inserted into holes 104,105 of the trailer hitch receiver tube 102 and through the holes 113, 114 of tube 112 of the shock absorbing trailer hitch attachment in order to secure the trailer hitch attachment to the vehicle. In the event that the driver of the primary vehicle wishes to insert a ball hitch attachment for towing, or insert any other trailer hitch attachment, the shock absorbing trailer hitch attachment of the present invention can be removed from the trailer hitch receiver by removing the hitch pin 106.

The embodiments described are illustrative of the present invention. All embodiments may be fabricated from multiple components, of the same materials as described or different materials having similar properties, characteristics and functionalities. Embodiments of the present invention may be manufactured out of hard, resilient, and resistant materials capable of withstanding low speed collisions and impacts. Such materials may include for example but not be limited to iron, steel, stainless steel, chrome, silicon, acetal resin (hard plastic), rubber or equivalent materials having similar properties, characteristics and functionalities. The present invention may be made from hollow and/or solid materials or a combination of such materials that are strong enough, resilient enough and resistant enough to withstand the forces resulting from low speed vehicle collisions and impacts. Components of the shock absorbing trailer hitch attachment of the present invention may be constructed from many different materials or combinations of different materials that provide resilient, resistant and shock absorbing capabilities. Equivalent shock absorbing components and structures such as resilient accordion members and folding members may be substituted for the resilient spring to withstand forces created as a result of collision or impact. Although the primary function of the present invention is to provide shock absorbing capabilities for vehicles, its benefits in reducing and limiting damage due to collisions and impacts may also be used in a variety of other applications.

What is claimed is:

1. A trailer hitch attachment with shock absorbing capabilities for vehicle protection, comprising:
an insertion member capable of being inserted at least partially into a vehicle trailer hitch receiver;
a resilient member attached to said insertion member; and
an end-cap.

2. The trailer hitch attachment of claim 1, wherein the insertion member is secured to the trailer hitch receiver by a locking pin.

3. The trailer hitch attachment of claim 1, wherein the resilient member rests against the perimeter of the opening of a trailer hitch receiver tube.

4. The trailer hitch attachment of claim 3, wherein the resilient member comprises a spring.

5. The trailer hitch attachment of claim 1, wherein the insertion member further comprises interlocking tubular members.

6. The trailer hitch attachment of claim 5, wherein the resilient member resides within said tubular members.

7. The trailer hitch attachment of claim 5, wherein the resilient member resides at least partially within the confines of the vehicle's trailer hitch receiver when the trailer hitch attachment is mounted on the vehicle.

8. A method of shock absorption, comprising:
securing a resilient member to an insertion member suitable for insertion at least partially into a vehicle trailer hitch receiver; and
mounting the resilient member against the vehicle's trailer hitch receiver to allow for compression of the resilient member.

9. A trailer hitch attachment with shock absorbing capabilities for vehicle protection, comprising:
a tube for insertion at least partially into a vehicle trailer hitch receiver, said tube secured with a trailer hitch pin;
a coil spring attached to the tube; and
an end-cap.

10. The trailer hitch attachment of claim 9, wherein said coil spring and end-cap extend no more than about 6 inches from the vehicle trailer receiver tube.

11. The trailer hitch attachment of claim 10 wherein the compressibility of the coil spring is no more than about 3 inches to about 6 inches.

12. The trailer hitch attachment of claim 1, wherein the trailer hitch attachment provides aesthetic value for the vehicles trailer hitch.

13. The trailer hitch attachment of claim 1, wherein the trailer hitch attachment extends out from the vehicle trailer hitch receiver tube by approximately 5 inches; and the compression ability of the resilient member may exceed approximately 3 inches.

14. The trailer hitch attachment of claim 1, wherein the resilient member comprises a compression spring residing within said insertion member.

15. The trailer hitch attachment of claim 1, wherein the said resilient member comprises a resilient accordion or folding member.

16. The trailer hitch attachment of claim 6, wherein the resilient member comprises a resilient accordion or folding member.

17. The trailer hitch attachment of claim 1, wherein the trailer hitch attachment acts as a resistance sensor for the driver.

18. The trailer hitch attachment of claim 1, wherein the insertion member comprises a tubular member having an outer dimension approximating the nominal dimension of the vehicle trailer hitch receiver tube.

19. The trailer hitch attachment with shock absorbing capabilities for vehicle protection, comprising:
inner and outer interlocking tubes;
said outer tube capable of insertion at least partially into a vehicle trailer hitch receiver and being secured in place with a trailer hitch pin;
an end-cap attached to the non-interlocking end of the inner tube; and
a coil spring residing within the inner and outer interlocking tubes, said coil spring having one end resting against the hitch pin and the opposite end resting against the end-cap.

20. The trailer hitch attachment of claim 19, wherein said coil spring and end-cap extend no more than about approximately 6 inches from the vehicle trailer receiver tube.
